(19) United States
(12) Patent Application Publication
(10) Pub. No.: US 2022/0190337 A1
(43) Pub. Date: Jun. 16, 2022

(54) NEGATIVE ELECTRODE PLATE FOR NON-AQUEOUS ELECTROLYTE SECONDARY BATTERY

(71) Applicant: Prime Planet Energy & Solutions, Inc., Tokyo (JP)

(72) Inventors: Naoki UCHIDA, Kakogawa-shi (JP); Tetsuya MATSUDA, Kasai-shi (JP); Haruya NAKAI, Toyonaka-shi (JP)

(21) Appl. No.: 17/547,153

(22) Filed: Dec. 9, 2021

(30) Foreign Application Priority Data
Dec. 14, 2020 (JP) 2020-206542

(51) Int. Cl. H01M 4/583

(52) U.S. Cl. CPC H01M 4/583; H01M 2004/027

(57) ABSTRACT

A negative electrode plate for a non-aqueous electrolyte secondary battery includes a negative electrode substrate and a negative electrode active material layer. The negative electrode active material layer is placed on a surface of the negative electrode substrate. The negative electrode active material layer includes negative electrode active material particles and carboxymethylcellulose. The negative electrode active material particles include graphite. Volume-based particle size distribution of the negative electrode active material particles satisfies relationships of expression (I) “16 μm≤D50≤20 μm” and expression (II) “(D90−D10)/D50≤1”. The carboxymethylcellulose has a weight average molecular weight from 350,000 to 370,000. The carboxymethylcellulose has a degree of etherification from 0.65 to 0.82.

This nonprovisional application is based on Japanese Patent Application No. 2020-206542 filed on Dec. 14, 2020, with the Japan Patent Office, the entire contents of which are hereby incorporated by reference.

### BACKGROUND OF THE INVENTION

### Field of the Invention

The present technique relates to a negative electrode plate for a non-aqueous electrolyte secondary battery.

### Description of the Background Art

Japanese Patent Laying-Open No. 2011-204576 discloses a water-soluble polymer with a molecular weight of 200,000 or more and a degree of etherification of 0.8 or less.

### SUMMARY OF THE INVENTION

Hereinafter, in this specification, a negative electrode plate for a non-aqueous electrolyte secondary battery may be simply called “a negative electrode plate”, and a non-aqueous electrolyte secondary battery may be simply called “a battery”

A negative electrode plate includes a negative electrode substrate and a negative electrode active material layer. Generally, the negative electrode plate is produced by application of a negative electrode slurry. The negative electrode slurry may be prepared by mixing negative electrode active material particles, carboxymethylcellulose (CMC), and a dispersion medium (water). In the negative electrode slurry, CMC functions as a thickener. More specifically, CMC renders the negative electrode slurry viscous and enhances the dispersion stability of the negative electrode active material particles.

The negative electrode slurry is applied to a surface of the negative electrode substrate to form a film. The film is dried to form the negative electrode active material layer. The film is required to have a uniform mass per unit area for the entire film. However, in a plan view, at the periphery of the film, the mass per unit area tends to vary.

FIG. 1 is a conceptual cross-sectional view illustrating a first example of variation in mass per unit area.

A film 2 is formed on a surface of a negative electrode substrate 21. For example, in a plan view, the mass per unit area at the periphery of film 2 may be locally high. In this case, in a cross-sectional view (FIG. 1), both end portions of film 2 are raised. With both end portions of film 2 being raised this way, in the subsequent roll-to-roll process (winding, rolling, and/or the like), a negative electrode plate 20 tends to slacken. The presence of slack may impair productivity.

FIG. 2 is a conceptual cross-sectional view illustrating a second example of variation in mass per unit area.

For example, in a plan view, the mass per unit area at the periphery of film 2 may be locally low. In this case, in a cross-sectional view (FIG. 2), the central portion of film 2 is raised. This may impair, at both end portions of the negative electrode active material layer (film 2 after dried), the capacity balance with a positive electrode plate. When the capacity balance is impaired, cycling performance may be degraded, for example.

An object of the technique according to the present application (herein also called “the present technique”) is to provide a negative electrode plate with a small variation in mass per unit area.

Hereinafter, the configuration and effects of the present technique will be described. It should be noted that the action mechanism according to the present technique includes presumption. The scope of the present technique should not be limited by whether or not the action mechanism is correct.

A negative electrode plate for a non-aqueous electrolyte secondary battery includes a negative electrode substrate and a negative electrode active material layer. The negative electrode active material layer is placed on a surface of the negative electrode substrate. The negative electrode active material layer includes negative electrode active material particles and carboxymethylcellulose. The negative electrode active material particles include graphite. Volume-based particle size distribution of the negative electrode active material particles satisfies relationships of the following expressions (I) and (II):

16 μm≤D50≤20 μm (I)

(D90−D10)/D50≤1 (II).

The carboxymethylcellulose has a weight average molecular weight from 350,000 to 370,000. The carboxymethylcellulose has a degree of etherification from 0.65 to 0.82.

The variation in mass per unit area seems to be in correlation with the structural viscosity of the negative electrode slurry. More specifically, when the negative electrode slurry does not exhibit a sufficient structural viscosity, the negative electrode active material particles may sediment or the slurry viscosity may decrease. This seems to cause both end portions of the film to be raised (see FIG. 1). On the other hand, when the negative electrode slurry exhibits excessive structural viscosity, the fluidity of the negative electrode slurry may decrease. This seems to cause the central portion of the film to be raised (see FIG. 2).

The structural viscosity may change depending on how the negative electrode active material particles and the CMC are entangled. According to new findings from the present technique, the structural viscosity of the negative electrode slurry may be adjusted by changing the powder properties of the negative electrode active material particles and the polymer properties of the CMC. When the negative electrode active material particles satisfy the relationships of the above expressions (I) and (II) and the CMC has a specific weight average molecular weight and a specific degree of etherification, the variation in mass per unit area tends to be small. It may be because a preferable structural viscosity is exhibited.

The foregoing and other objects, features, aspects and advantages of the present technique will become more apparent from the following detailed description of the present technique when taken in conjunction with the accompanying drawings.

### BRIEF DESCRIPTION OF THE DRAWINGS

FIG. 1 is a conceptual cross-sectional view illustrating a first example of variation in mass per unit area.

FIG. 2 is a conceptual cross-sectional view illustrating a second example of variation in mass per unit area.

FIG. 3 is a schematic view of a non-aqueous electrolyte secondary battery according to the present embodiment.

FIG. 4 is a schematic view of an electrode assembly according to the present embodiment.

### DESCRIPTION OF THE PREFERRED EMBODIMENTS

In the following, an embodiment of the present technique (also called “the present embodiment” hereinafter) will be described. It should be noted that the below description does not limit the scope of the present technique.

Expressions such as “comprise, include”, “have”, and variations thereof (such as “be composed of”, “encompass, involve”, “contain”, “carry, support”, and “hold”, for example) herein are open-ended expressions. In other words, each of these expressions includes a certain configuration, but this configuration is not necessarily the only configuration that is included. The expression “consist of” is a closed-end expression. The expression “consist essentially of” is a semiclosed-end expression. In other words, the expression “consist essentially of” means that an additional component may also be included in addition to an essential component or components, unless an object of the present technique is impaired. For example, a component that is usually expected to be included in the relevant field to which the present technique pertains (such as inevitable impurities, for example) may be included as an additional component.

A singular form (“a”, “an”, and “the”) herein also includes its plural meaning, unless otherwise specified. For example, “a particle” may include not only “a single particle” but also “a group of particles (particles, powder)”.

“In a plan view” herein means to view a negative electrode plate and/or the like (a film, a negative electrode active material layer) in a direction parallel to a thickness direction of the negative electrode plate and/or the like. “In a cross-sectional view” herein means to view a negative electrode plate and/or the like in a direction perpendicular to a thickness direction of the negative electrode plate and/or the like.

A numerical range such as “from 16 μm to 20 μm” herein includes both the upper limit and the lower limit, unless otherwise specified. For example, “from 16 to 20 μm” means a numerical range of “not less than 16 μm and not more than 20 μm”. Moreover, any numerical value selected from the numerical range may be used as a new upper limit and/or a new lower limit. For example, any numerical value from the numerical range and any numerical value described in another location of the present specification may be combined to create a new numerical range.

The dimensional relationship in each figure may not necessarily coincide with the actual dimensional relationship. The dimensional relationship (in length, width, thickness, and the like) in each figure may have been changed for the purpose of assisting the understanding of the present technique. Further, a part of a configuration may have been omitted.

<Non-Aqueous Electrolyte Secondary Battery>

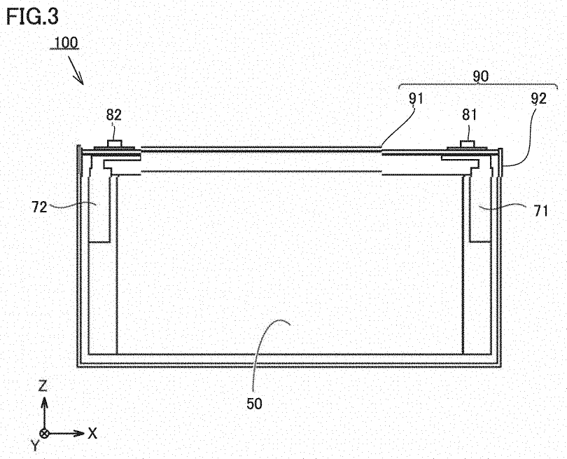

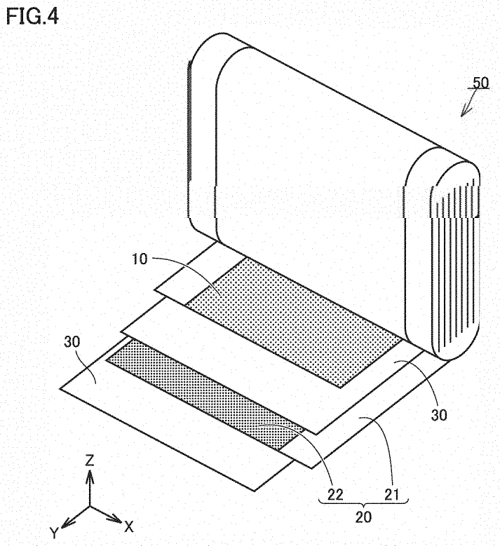

FIG. 3 is a schematic view of a non-aqueous electrolyte secondary battery according to the present embodiment.

A battery 100 may be used for any purpose of use. For example, battery 100 may be used as a main electric power supply or a motive force assisting electric power supply in an electric vehicle. A plurality of batteries 100 may be connected together to form a battery module or a battery pack.

Battery 100 includes a housing 90. Housing 90 is prismatic (a flat, rectangular parallelepiped). However, prismatic is merely an example. Housing 90 may have any configuration. Housing 90 may be cylindrical or may be a pouch, for example. Housing 90 may be made of Al (aluminum) alloy, for example. Housing 90 accommodates an electrode assembly 50 and an electrolyte solution (not illustrated). Electrode assembly 50 is impregnated with the electrolyte solution. The electrolyte solution includes a non-aqueous solvent and a lithium salt, for example. Housing 90 may include a sealing plate 91 and an exterior can 92, for example. Sealing plate 91 closes an opening of exterior can 92. Sealing plate 91 and exterior can 92 may be bonded together by laser beam welding and/or the like, for example.

Sealing plate 91 is provided with a positive electrode terminal 81 and a negative electrode terminal 82. Sealing plate 91 may be further provided with an inlet and a gas-discharge valve. Through the inlet, the electrolyte solution may be injected into housing 90. Electrode assembly 50 is connected to positive electrode terminal 81 via a positive electrode current-collecting member 71. Positive electrode current-collecting member 71 may be an Al plate and/or the like, for example. Electrode assembly 50 is connected to negative electrode terminal 82 via a negative electrode current-collecting member 72. Negative electrode current-collecting member 72 may be a Cu (copper) plate and/or the like, for example.

FIG. 4 is a schematic view of an electrode assembly according to the present embodiment.

Electrode assembly 50 is a wound-type one. Electrode assembly 50 includes a positive electrode plate 10, a separator 30, and a negative electrode plate 20. In other words, battery 100 includes positive electrode plate 10, negative electrode plate 20, and an electrolyte solution. Each of positive electrode plate 10, separator 30, and negative electrode plate 20 is a belt-shaped sheet. Positive electrode plate 10 includes a positive electrode active material [such as Li(NiCoMn)O₂, for example]. Separator 30 is a porous sheet. Separator 30 may consist of a polyolefin-based resin, for example. Electrode assembly 50 may include a plurality of separators 30. Electrode assembly 50 is formed by stacking positive electrode plate 10, separator 30, and negative electrode plate 20 in this order and then winding them spirally. One of positive electrode plate 10 and negative electrode plate 20 may be interposed between separators 30. Both positive electrode plate 10 and negative electrode plate 20 may be interposed between separators 30. After the winding, electrode assembly 50 is shaped into a flat form. The wound-type one is merely an example. Electrode assembly 50 may be a stack-type one, for example.

<Negative Electrode Plate>

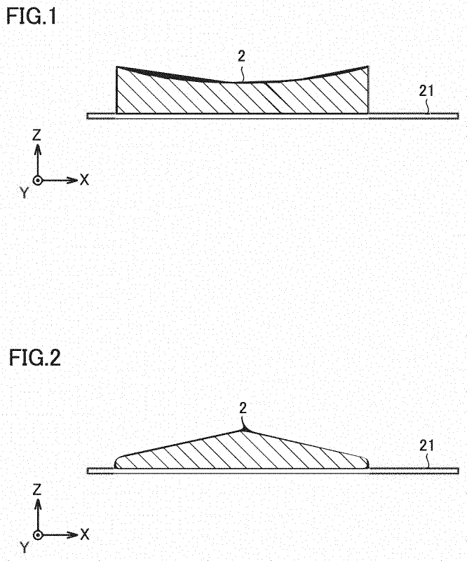

Negative electrode plate 20 includes a negative electrode substrate 21 and a negative electrode active material layer 22. Negative electrode substrate 21 may be a Cu foil and/or the like, for example. Negative electrode substrate 21 may have a thickness from 5 μm to 30 μm, for example. Negative electrode active material layer 22 is placed on a surface of negative electrode substrate 21. Negative electrode active material layer 22 may be formed on only one side of negative electrode substrate 21. Negative electrode active material layer 22 may be formed on both sides of negative electrode substrate 21. Negative electrode active material layer 22 may have a thickness from 10 μm to 200 μm, for example. Negative electrode active material layer 22 may be formed by application of a negative electrode slurry. The negative electrode slurry may be applied by a slot die method, for example. Mass per unit area tends to vary in, for example, a direction perpendicular to the direction of application (the direction of work transfer) (namely, in the X-axis direction in FIGS. 1 and 2).

Negative electrode active material layer 22 includes negative electrode active material particles and CMC. Negative electrode active material layer 22 may consist essentially of negative electrode active material particles and CMC. In addition to the negative electrode active material particles and CMC, negative electrode active material layer 22 may further include a conductive material, a rubber-based binder, and/or the like, for example.

(Negative Electrode Active Material Particles)

The negative electrode active material particles include graphite. The negative electrode active material particles may consist essentially of graphite. The graphite may be artificial graphite or may be natural graphite. In addition to the graphite, the negative electrode active material particles may further include an additional component. The negative electrode active material particles may further include, for example, a pitch-based carbon material and/or the like. For example, a surface of the graphite particle may be covered with a pitch-based carbon material. For example, the negative electrode active material particles may have been subjected to spheronization treatment. The negative electrode active material particles may have an average circularity from 0.8 to 1.0, for example.

(Particle Size Distribution of Negative Electrode Active Material Particles)

Particle size distribution of the negative electrode active material particles is measured by laser diffraction method. More specifically, the particle size distribution is measured by introducing a suspension liquid (a measurement sample) into a measurement member (a flow cell) of a laser-diffraction particle size distribution analyzer. The measurement sample is prepared by dispersing the negative electrode active material particles and a dispersant in a dispersion medium (ion-exchanged water). The dispersant is “TRITON (registered trademark) X-100”. Alternatively, a material equivalent to this dispersant may be used.

The particle size distribution according to the present embodiment is based on volume. “D10” is defined as a particle size in the particle size distribution at which the cumulative volume (accumulated from the side of small sizes) reaches 10% of the total volume. “D50” is defined as a particle size in the particle size distribution at which the cumulative volume (accumulated from the side of small sizes) reaches 50% of the total volume. “D90” is defined as a particle size in the particle size distribution at which the cumulative volume (accumulated from the side of small sizes) reaches 90% of the total volume.

The D50 of the negative electrode active material particles affects the structural viscosity of the negative electrode slurry. The D50 according to the present embodiment is from 16 μm to 20 μm. The D50 may be 17.1 μm or more, for example. The D50 may be 18.1 μm or less, for example.

The left side of the above expression (II), “(D90−D10)/D50”, is also called a span. The smaller the span is, the smaller the width of the particle size distribution is. The span of the negative electrode active material particles affects the structural viscosity of the negative electrode slurry. The span according to the present embodiment is 1 or less. The span may be 0.87 or more, for example.

(Carboxymethylcellulose)

The CMC according to the present embodiment is a sodium salt (CMC-Na). The CMC may be a lithium salt (CMC-Li), an ammonium salt (CMC-NH₄), and/or the like, for example. Within the CMC, substantially all the carboxymethyl groups may include Na salt (—COONa). Within the CMC, some carboxymethyl groups may include carboxylic acid (—COOH). The CMC functions as a thickener in the negative electrode slurry. The CMC functions as a binder in negative electrode active material layer 22. The amount of the CMC may be, for example, from 0.1 parts by mass to 2 parts by mass, or may be from 0.5 parts by mass to 1 parts by mass, relative to 100 parts by mass of the negative electrode active material particles.

(Weight Average Molecular Weight of CMC)

The weight average molecular weight of the CMC affects the structural viscosity of the negative electrode slurry. It seems that the suitable range of the weight average molecular weight depends on the powder properties of the negative electrode active material particles. The CMC according to the present embodiment has a weight average molecular weight from 350,000 to 370,000. The CMC may have a weight average molecular weight of 355,000 or more, for example. The CMC may have a weight average molecular weight of 365,000 or less, for example.

The weight average molecular weight of the CMC is measured by gel permeation chromatography (GPC). For example, a high-performance GPC apparatus “HLC-8320GPC” manufactured by Tosoh Corporation and/or the like may be used. A GPC apparatus with equivalent functions may also be used. A 0.2% (mass concentration) aqueous CMC solution is prepared. To prepare the aqueous CMC solution, deionized water is used. The aqueous CMC solution is diluted with an eluent to prepare a diluted liquid. The eluent is an aqueous NaCl solution (molarity, 0.1 mol/L). The dilution factor is 8 folds. The diluted liquid is shaken sufficiently. After shaking, the diluted liquid is filtered through a cellulose acetate cartridge filter (pore size, 0.45 μm). The filtrate is used as a measurement sample. The column is configured by connecting one “TSKguardcolumn PWXL (6.0 mmI.D×4 cm)” (manufactured by Tosoh Corporation) and two “TSKgel GMPWXL (7.8 mmI.D×30 cm)” (manufactured by Tosoh Corporation) in series. The detector is an RI (refractive index detector). The measurement temperature is 40° C. The flow speed is 1 mL/min. The reference material is pullulan.

(Degree of Etherification of CMC)

The skeleton of the CMC is formed of many glucose molecules polymerized in a linear manner. Each glucose unit has three hydroxy groups (—OH). The degree of etherification refers to how many hydroxy groups on average among the three hydroxy groups are bonded with carboxymethyl groups, respectively, via an ether bond. The degree of etherification is also called a degree of substitution (DS). The degree of etherification of CMC affects the structural viscosity of the negative electrode slurry. It seems that the suitable range of the degree of etherification depends on the powder properties of the negative electrode active material particles. The CMC according to the present embodiment has a degree of etherification from 0.65 to 0.82. The CMC may have a degree of etherification of 0.75 or more, for example. The CMC may have a degree of etherification of 0.78 or less, for example.

The degree of etherification of CMC is measured by the below procedure. To 1 L of anhydrous methanol, 100 mL of guaranteed reagent-grade concentrated HNO₃ is mixed, and thereby nitric acid-methanol is prepared. 2 g of CMC (powder) is weighed. 2 g of CMC and 100 mL of nitric acid-methanol are placed in a plug-equipped triangle flask (volume, 300 ml). The plug-equipped triangle flask is shaken for 2 hours. By this, the terminus of a carboxymethyl group within the CMC is converted from Na salt (—COONa) to carboxylic acid (—COOH). After the conversion, the mixture in the plug-equipped triangle flask is suction-filtered through a glass filter. With a methanol aqueous solution (concentration, 80%), the residue (CMC) is rinsed. After rinsing, 50 mL of anhydrous methanol is added thereto, and another round of suction filtration is carried out. The residue (CMC) is dried at 105° C. for 2 hours. After drying, 1 g to 1.5 g of the CMC is weighed. The CMC (dry mass, 1 g to 1.5 g) is placed in a plug-equipped triangle flask (volume, 300 ml). 15 mL of a methanol aqueous solution (concentration, 80%) is added to the plug-equipped triangle flask, and thereby the CMC is made wet. Further, 50 mL of an aqueous NaOH solution (normality, 0.1 N) is added. After the addition of the aqueous NaOH solution, the plug-equipped triangle flask is shaken at room temperature for 2 hours. After shaking, with the use of H₂SO₄ (normality, 0.1 N), back titration of excess NaOH is carried out. The indicator is phenolphthalein.

Based on the titration results, the degree of etherification (DS) is calculated by the following expression.

A=0.1×(50×F′−(amount of H₂SO₄ (mL))×F)/(dry mass of CMC (g))

DS (mol/C6)=0.162 A/(1−0.058 A)

where F represents the factor of 0.1 N H₂SO₄, and F′ represents the factor of 0.1 N aqueous NaOH solution.

(Other Components)

Negative electrode active material layer 22 may further include a conductive material, for example. The conductive material may include an optional component. The conductive material may include carbon black, carbon nanotube, and/or the like, for example. The amount of the conductive material may be, for example, from 0.1 parts by mass to 10 parts by mass relative to 100 parts by mass of the negative electrode active material particles. Negative electrode active material layer 22 may further include a rubber-based binder, for example. The rubber-based binder may include an optional component. The rubber-based binder may include styrene-butadiene rubber (SBR) and/or the like, for example. The amount of the rubber-based binder may be, for example, from 0.1 parts by mass to 2 parts by mass, or may be from 0.5 parts by mass to 1 parts by mass, relative to 100 parts by mass of the negative electrode active material particles.

### EXAMPLES

Next, examples according to the present technique (hereinafter also called “the present example”) will be described. It should be noted that the below description does not limit the scope of the present technique.

<Production of Negative Electrode Plate>

In the below manner, negative electrode plates according to No. 1 to No. 11 were produced.

«No. 1»

The below materials were prepared.

Negative electrode active material particles: graphite powder (D50, 17.1 μm; span, 1)

CMC: CMC-Na (weight average molecular weight, 355,000, degree of etherification, 0.78)

Rubber-based binder: SBR

Dispersion medium: water

Negative electrode substrate: Cu foil

Graphite powder, CMC-Na, SBR, and water were mixed to prepare a negative electrode slurry. The solid matter ratio was “(graphite powder)/CMC-Na/SBR=100/0.5/1 (mass ratio)”. The negative electrode slurry was applied to a surface of the negative electrode substrate to form a film. The film was dried to form a negative electrode active material layer. The negative electrode active material layer was formed on both sides of the negative electrode substrate. Thus, a negative electrode plate was produced.

«No. 2 to No. 11»

Negative electrode plates were produced in the same manner as for No. 1 except that graphite powder having powder properties specified in Table 1 below was combined with CMC-Na having polymer properties specified in Table 1 below.

<Evaluation>

From the central portion (in a plan view) of the negative electrode active material layer, a sample fragment having a predetermined area was cut out. The mass per unit area and the thickness of the sample fragment were measured. The thickness was measured with “DIGIMICRO” manufactured by NIKON CORPORATION. From the mass per unit area and the thickness of the sample fragment, the density of the negative electrode active material layer was calculated. As for regions spanning from both end portions of the negative electrode active material layer to a distance of up to 3 mm, the thickness of the negative electrode active material layer was measured. From the density of the negative electrode active material layer and the thickness of both end portions, the average mass per unit area of both end portions was calculated.

By the following expression, the variation index for mass per unit area was calculated.

Variation index for mass per unit area={(mass per unit area of central portion)/(average mass per unit area of both end portions)}×100

In the present example, when the variation index for mass per unit area is from 95 to 105, it is considered that the variation in mass per unit area is small.

TABLE 1

| No. | | 1 | 2 | 3 | 4 | 5 | 6 | 7 | 8 | 9 | 10 | 11 |
|---|---|---|---|---|---|---|---|---|---|---|---|---|
| Graphite | D50 [μm] | 17.1 | 18.1 | 16.2 | 17.1 | 17.1 | 17.1 | 17.1 | 17.1 | 17.1 | 17.1 | 14.6 |
| Powder | Span | 1 | 0.87 | 1.1 | 1 | 1 | 1 | 1 | 1 | 1 | 1 | 1.14 |
| | (D90-D10)/D50 [—] | | | | | | | | | | | |
| CMC-Na | Weight average | 35.5 | 35.5 | 35.5 | 35 | 36.5 | 33 | 38 | 35.5 | 35.5 | 32 | 35.5 |
| | molecular weight | | | | | | | | | | | |
| | (Mw) × 10⁴ | | | | | | | | | | | |
| | Degree of | 0.78 | 0.78 | 0.78 | 0.8 | 0.75 | 0.82 | 0.78 | 0.65 | 0.82 | 0.87 | 0.78 |
| | etherification (DS) | | | | | | | | | | | |
| | [mol/C6] | | | | | | | | | | | |
| | Amount | 0.5 | 0.5 | 0.5 | 0.5 | 0.5 | 0.5 | 0.5 | 0.5 | 0.5 | 0.5 | 0.5 |
| | [parts by mass] | | | | | | | | | | | |
| Evaluation | Variation index for | 98 | 97 | 93 | 98 | 96 | 107 | 93 | 96 | 101 | 110 | 93 |
| | mass per unit area | | | | | | | | | | | |
| | [—] | | | | | | | | | | | |

<Results>

When all the conditions listed below are satisfied in Table 1 above, the variation in mass per unit area tends to be small.
The D50 of the negative electrode active material particles is from 16 μm to 20 μm.
The span of the negative electrode active material particles is 1 or less.
The weight average molecular weight of CMC is from 350,000 to 370,000.
The degree of etherification of CMC is from 0.65 to 0.82.

<Additional Statement>
The D50 of the negative electrode active material particles may be from 17.1 μm to 18.1 μm.
The span of the negative electrode active material particles may be from 0.87 to 1.
The weight average molecular weight of CMC may be from 350,000 to 365,000.

The present technique also relates to a method of producing a negative electrode plate.

The method of producing a negative electrode plate includes the following (A) to (C):

(A) Mixing negative electrode active material particles, carboxymethylcellulose, and a dispersion medium to prepare a negative electrode slurry;

(B) Applying the negative electrode slurry to a surface of a negative electrode substrate to forms a film; and

(C) Drying the film to form a negative electrode active material layer.

The negative electrode active material particles include graphite. The volume-based particle size distribution of the negative electrode active material particles satisfies relationships of the following expressions (I) and (II):

16 μm≤D50≤20 μm (I)

(D90−D10)/D50≤1 (II).

The carboxymethylcellulose has a weight average molecular weight from 350,000 to 370,000, and a degree of etherification from 0.65 to 0.82.

The negative electrode slurry exhibits structural viscosity. The structural viscosity means that the apparent viscosity, which is defined as the ratio of shear stress and shear rate, decreases along with the increase of the shear rate.

The apparent viscosity is defined by the following expression (III):

η=τ/γ (III)

where η represents apparent viscosity; τ represents shear stress; and γ represents shear rate.

The present embodiment and the present example are illustrative in any respect. The present embodiment and the present example are non-restrictive. The scope of the present technique encompasses any modifications within the meaning and the scope equivalent to the terms of the claims. For example, it is expected that certain configurations of the present embodiments and the present examples can be optionally combined. In the case where a plurality of functions and effects are described in the present embodiment and the present example, the scope of the present technique is not limited to the scope where all these functions and effects are obtained.

What is claimed is:

1. A negative electrode plate for a non-aqueous electrolyte secondary battery, comprising:
a negative electrode substrate; and
a negative electrode active material layer, wherein
the negative electrode active material layer is placed on a surface of the negative electrode substrate,
the negative electrode active material layer includes negative electrode active material particles and carboxymethylcellulose,
the negative electrode active material particles include graphite,
volume-based particle size distribution of the negative electrode active material particles satisfies relationships of expressions (I) and (II):
16 μm≤D50≤20 μm (I)
(D90−D10)/D50≤1 (II), and
the carboxymethylcellulose has:
a weight average molecular weight from 350,000 to 370,000; and
a degree of etherification from 0.65 to 0.82.

2. The negative electrode plate for a non-aqueous electrolyte secondary battery according to claim 1, wherein the particle size distribution satisfies a relationship of:
17.1 μm≤D50≤18.1 μm.

3. The negative electrode plate for a non-aqueous electrolyte secondary battery according to claim 1, wherein the particle size distribution satisfies a relationship of:
0.87≤(D90−D10)/D50≤1.

4. The negative electrode plate for a non-aqueous electrolyte secondary battery according to claim 1, wherein the carboxymethylcellulose has a weight average molecular weight from 350,000 to 365,000.
